(19) United States
(12) Patent Application Publication
(10) Pub. No.: US 2010/0307660 A1
(43) Pub. Date: Dec. 9, 2010

(54) Device and Method for Ultrasonic Treatment

(75) Inventor: Hartmut Moeglich, Ettlingen (DE)

Correspondence Address: SHOEMAKER AND MATTARE, LTD, 10 POST OFFICE ROAD - SUITE 100, SILVER SPRING, MD, 20910, US

(73) Assignee: TELSONIC HOLDING AG, Bronschhofen (CH)

(21) Appl. No.: 12/796,306

(22) Filed: Jun. 8, 2010

(30) Foreign Application Priority Data
Jun. 8, 2009 (EP) 09162197.9

(51) Int. Cl. B29C 65/08

(52) U.S. Cl. 156/73.4; 156/580.2

(57) ABSTRACT

A device for the ultrasonic welding of two films of plastic includes a sonotrode (2), which can be induced to undergo torsional ultrasonic vibrations by means of exciters (23, 24). The sonotrode (2) has a slit (4), in which an engaging element (5) of an anvil (3) is inserted, so that a welding gap for the two films of plastic (11, 12) is formed. To achieve a welded joint, the films are guided through the welding gap.

The invention relates to a device and a method for ultrasonic treatment according to the preamble of the independent claims. With a device of this type it is possible, for example, for two films of plastic one lying flat on the other to be joined to each other at the borders (ultrasonic welding). For example, tubular bags for packaging a product or item to be packaged can be produced in this way. With the device according to the invention it is also possible to apply notches in films (for example as an aid for tearing open), in which case only one film could be processed in the device for this purpose. Finally, separation sealing methods are also covered by the invention.

Devices for so-called torsional ultrasonic welding have been known and customary for some time. Such a welding device is disclosed, for example, by EP 930 148 A1. The device includes a sonotrode, which can be induced to undergo ultrasonic vibrations by means of exciters. Opposite the sonotrode there is a so-called anvil, which has a moulding receptacle for receiving a plastic housing. For example, with this device, a cover can be firmly welded onto the plastic housing. The parts to be joined to each other are not moved during the welding process, at least with respect to the longitudinal axis of the sonotrode. The device is consequently suitable for stationary welding; however, the device is not suitable for continuous welding, for example of endless films. Moreover, with this device, two films cannot be joined to each other in a suitable way, and in particular not at the borders.

It is therefore an object of the present invention to avoid the disadvantages of the known art and, in particular, to provide a device and a method of the type stated at the beginning with which two sheet-like articles can be joined to each other in a simple and advantageous manner. In particular, the device and the method are intended to be suitable for joining two or more film parts to each other at the borders. The device is, however, also intended to make it possible to create notches or ultrasonically separate and seal at least one article. Furthermore, the method is intended to be distinguished by an efficient and reliable mode of operation.

These other objects are achieved according to the invention by a device and a method according to the independent patent claims.

The device according to the invention has a sonotrode which can be induced to undergo torsional ultrasonic vibrations by means of exciters. Sonotrodes of this type are also known to a person skilled in the art by the term “torsion sonotrode”. Torsional is understood as meaning a vibration of the sonotrode about its longitudinal axis, i.e. the sonotrode performs a torsional movement about a torsion axis (longitudinal axis). The device also has an anvil lying opposite the sonotrode. At least one article can be guided through between the sonotrode and the anvil to achieve notching (scoring) or separating (separating and sealing) or at least two articles can be guided through between the sonotrode and the anvil to achieve a welded joint. In this case, the anvil has an engaging portion, along which the at least one article or the at least two articles can be guided. The sonotrode has a working area for subjecting the at least one article to ultrasonic vibrations, the engaging portion and/or the working area extending at least in certain portions approximately parallel to the longitudinal axis of the sonotrode, at least in a neutral position. The articles can be guided through continuously between the engaging portion and the working area. The working area undergoes vibrations, which extend approximately perpendicularly to it.

In an advantageous embodiment, the sonotrode may have at least one slit, into which an engaging element of the anvil can be inserted, or is inserted, so that a gap for the at least one article is formed. For the aforementioned case in which two articles are guided through between the sonotrode and the anvil to achieve a welded joint, the term “welding gap” is used for the gap. Two films (parts thereof), one lying flat on the other, for example, may be guided by their borders through the welding gap between the sonotrode and the anvil and welded in this way. With this device, continuous longitudinal weld seams can be produced in a simple manner. It goes without saying, however, that a discontinuous operating mode, in which the individual weld seams are interrupted by unwelded portions, is also possible with this device. With the device, films of plastic or else metal foils (for example aluminium foils) as well as coated films can be advantageously processed. The films may be drawn through the welding gap by conveying means or be moved in some other way. This guiding of the borders of the film through the welding gap formed between the engaging element and the working area ensures reliable and efficient operation during a welding process. In principle, the device is suitable for joining different types of articles. For example, with the device, a film-like cover could also be welded onto a container provided with a collar.

In the latter application, the collar would have to be guided through the arrangement with the welding gap along the collar. Apart from the advantages already mentioned, the device may also be favourably inserted and used in an automatic production line. If the beginning of the actual welding gap (for example formed by a rocking edge) extends approximately centrally, i.e. through or alongside the sonotrode axis, the amplitude in a central region is zero, or in any event very small. Towards the periphery of the sonotrode, the amplitude increases. In this way, a continuous increase can be achieved.

The working area may be created by a corresponding configuration at least of the end face of the sonotrode that is facing the anvil. For example, a tongue extending in the axial direction (for example a flattened profile extending in the axial direction) may be formed onto the end face of the sonotrode or be attached in some other manner. The working area may also be provided by a step-like cutout being made in the region of the end face of the sonotrode. It would even also be conceivable that—instead of the sonotrode—the anvil could have at least one slit. The engaging element would in this case consequently be assigned to the sonotrode. In this case, the engaging element assigned to the sonotrode could be configured as, for example, a pin-shaped tongue extending in the direction of the longitudinal axis. The provision of one or more slits in the sonotrode is therefore not absolutely necessary for certain applications.

Theoretically, it is then even conceivable that the device could be provided with a number of parallel extending or even crossing slits. Preferably, however, the sonotrode has only one slit.

In a first embodiment, the slit may be a groove extending in a groove direction, it being possible for the groove direction to extend transversely, preferably at right angles, to the longitudinal axis of the sonotrode and/or have side walls which extend parallel to the longitudinal axis and form the working area. The groove direction also defines moreover the direction of advancement of the articles during welding operation. The slit is advantageously configured as a continuous groove, it being possible for the groove cross section preferably to be rectangular. Consequently, two films of plastic placed one on the other can be drawn by the borders particularly easily in the groove direction through the slit or through the welding gap.

It may be particularly advantageous if the slit is a groove which is recessed with respect to an end face in the direction of the longitudinal axis of the sonotrode. This recess establishes the groove depth. For the first-mentioned variant, in which the slit is assigned to the sonotrode and the engaging element is assigned to the anvil, the side of the sonotrode that is facing the anvil may form the said end face.

The groove depth of the slit establishes the upper limit for the weld seam width. The width of the weld seam may be approximately the depth of penetration of the engaging element into the slit. The slit may have a groove depth which lies between 5 and 30 mm and preferably between 10 and 15 mm. The groove width may lie between 5 and 15 mm and, with a sonotrode diameter of 40-50 mm, preferably be approximately 10 mm. The engaging element corresponding to the slit may have an undersize with respect to the extent of the width. The welding gap width depends on the film material and the film thickness. The width of the welding gap (gap size) varies for commonly used film thicknesses (for example 20-150 μm).

In a further embodiment, the slit may have two side walls lying opposite each other, it being possible for one of the side walls to form a working area for subjecting the at least one article to ultrasonic vibrations. In this case, the anvil or the sonotrode may have an engaging portion facing the working area, the welding gap lying between the working area and the engaging portion. The engaging portion may form a guiding area for a film part. During a welding process, the articles can slide along on one side on this guiding area with surface-area contact and the articles can be subjected to ultrasonic vibrations on the other side by the working area.

The engaging element or the sonotrode may be supportable or supported by spring means for producing a prestressed pressure for pressing against a working area of the slit. With the spring arrangement, an advantageous gap compensation is obtained. This makes it possible, for example, to compensate for suddenly occurring thick locations (for example a film splice, folds, etc.) when the at least one article is being guided through. In particular, in this way it is possible, for example, for films of plastic or other film parts and very thin articles, such as membranes for instance, to be protected in a simple manner from being damaged. This arrangement also allows the joining of successive overlapping film webs (known as splicing).

To set the width of the welding gap or to set the pressing pressure produced by the spring means, the engaging element or a part of the anvil that is assigned to the gap may be movably secured to an anvil holder by means of an adjusting mechanism. This allows the device to be adapted in a simple manner to different thicknesses of articles to be welded. In addition or alternatively, the device may have an adjusting mechanism, with the aid of which the angular position of the engaging element with respect to the gap is adjustable. With the angular position adjustment it is possible as far as the neutral position is concerned to set an exact plane parallelism of the working area and the engaging portion or an opening or narrowing welding gap, whichever is desired.

The engaging element of the anvil or a part of the anvil that is assigned to the gap may be mounted on an anvil holder pivotably (or tiltably) about a pivot axis. The pivot axis may in this case extend axially parallel to the longitudinal axis of the sonotrode. The pivot axis may, for example, be defined by an axial journal and a complementary pivot bearing. It goes without saying, however, that it is also conceivable that the device could have an imaginary pivot axis. For example, the engaging element may be supported on the anvil holder only by two laterally arranged springs, whereby a pivoting or tilting movement of the engaging element would likewise be possible.

Advantages may be obtained if the engaging element is of an approximately U-shaped or bow-shaped configuration. In this case, to form the U or bow shape, the engaging element may have two securing arms and a web portion connecting them. The web portion may in this case be received, or able to be received, in the slit. The engaging element may be positioned or aligned in such a way that the U lies on a plane of which the normal to its surface extends parallel to the longitudinal axis.

It may be particularly advantageous if a spring element, for example a helical compression spring, is respectively provided for resilient support in the connecting region between an anvil holder and the securing arms.

Advantageous welding can be achieved if the engaging element is longer than the gap with respect to the groove direction and preferably protrudes beyond the gap on both sides. If, for example, the engaging element is of a U-shaped or bow-shaped configuration, the securing arms may be respectively formed on the part of the web portion that protrudes beyond the gap.

The engaging element including the two securing arms and the web portion may be configured as a one-piece body of metal (for example steel). One-piece components of this type can be produced in a simple manner by milling operations.

The engaging element may have an edge in the region of the engaging portion. The edge may, for example, be a rocking edge which is adjoined by a tapering area. The edge may be located in the centre of the engaging element. The edge may furthermore be positioned in the device in such a way that it lies approximately in the centre of the slit with respect to the groove direction.

Theoretically, it is conceivable that the engaging portion is convexly curved in a plan view.

For certain applications, it may be advantageous if the working area formed by a side wall is planar.

However, it may also be advantageous if the working area formed by a side wall is contoured. For example, the side wall could be provided with a plurality of projections, for example approximately punctiform projections, whereby the two articles can be subjected to ultrasonic vibrations at discrete points.

However, it may be particularly advantageous if the contour is formed by at least one rib-like projection. The contour in this case preferably has a number of rib-like projections. The contour may have longitudinal ribs extending in the groove direction.

In a further embodiment, the engaging element or the slit may have a supporting segment for the axial support of the sonotrode. The supporting segment may extend in the direction of the longitudinal axis. The supporting segment may in this case be positioned, at least in a working position, in such a way that the supporting segment defines a point of engagement which preferably lies in the longitudinal axis of the sonotrode. Such a central point of engagement produces a fixed stop or zero-point contact, which is not involved in the vibration occurring in the ultrasonic welding process. The supporting segment may, for example, be a cone-shaped projection formed at the base of the slit or secured in some other way. An advantageous stop in the form of a point is ensured by the tip of the cone. It goes without saying that, apart from the cone shape, other shapings for the projection are also conceivable.

A further aspect of the invention concerns a method for the ultrasonic welding of at least two preferably sheet-like articles. The method may be performed in an advantageous manner on the device described above. The method is distinguished by the fact that, for example, to produce a longitudinal seam, the at least two articles are guided through a welding gap formed between a working area of a torsion sonotrode and an engaging portion.

The working area extends approximately parallel to the axis of the torsion sonotrode. In the case of the present ultrasonic welding method, the articles are subjected to ultrasonic vibrations approximately perpendicularly to them by means of a torsionally vibrating sonotrode which has at least one slit.

Further individual features and advantages of the invention emerge from the following description of the exemplary embodiments and from the drawings, in which:

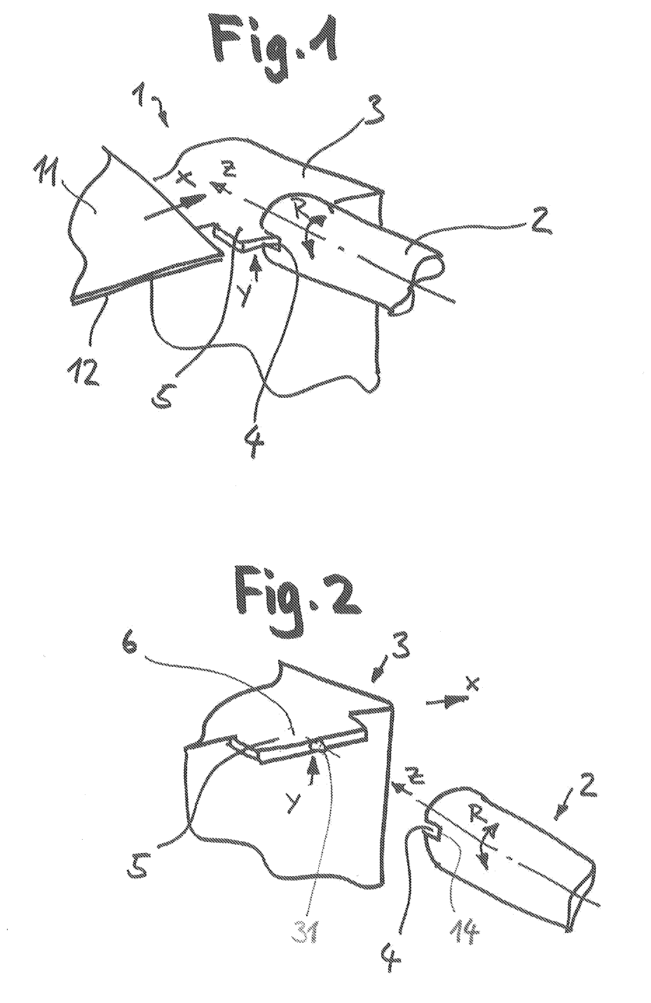

FIG. 1 shows a perspective, greatly simplified representation of a device according to the invention for ultrasonic welding in a working position,

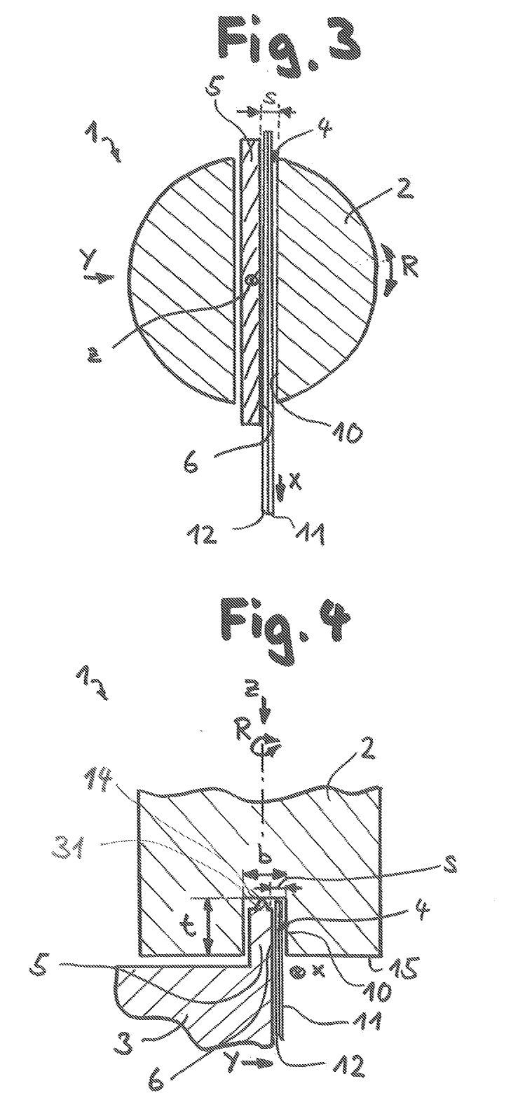

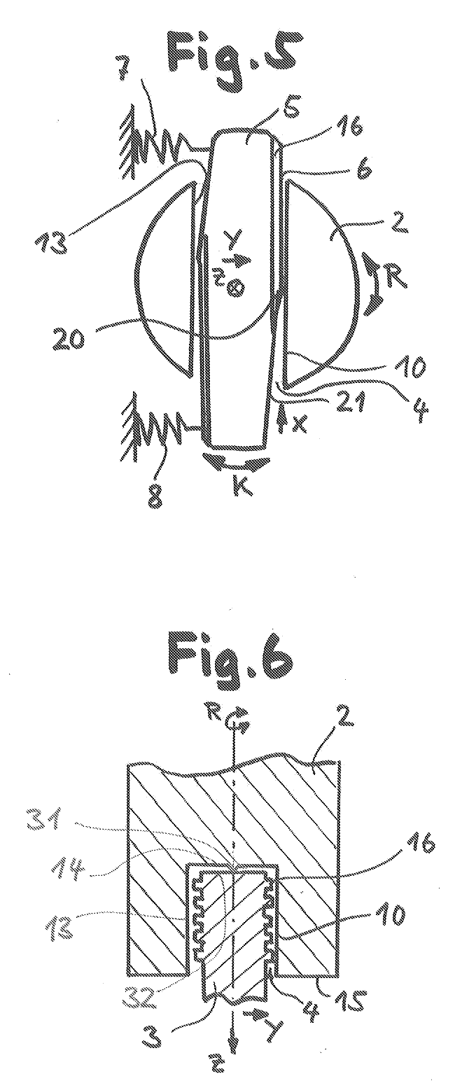

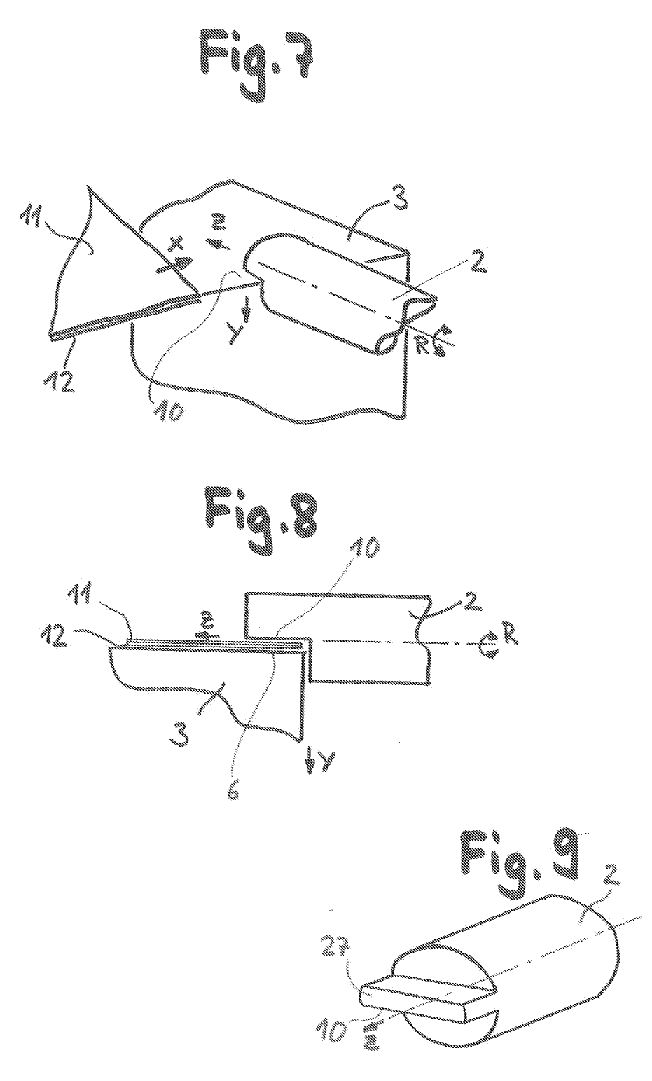

FIG. 2 shows the device according to FIG. 1 with a sonotrode in a rest position,

FIG. 3 shows a cross section through the device according to FIG. 1 (sectional plane x-y),

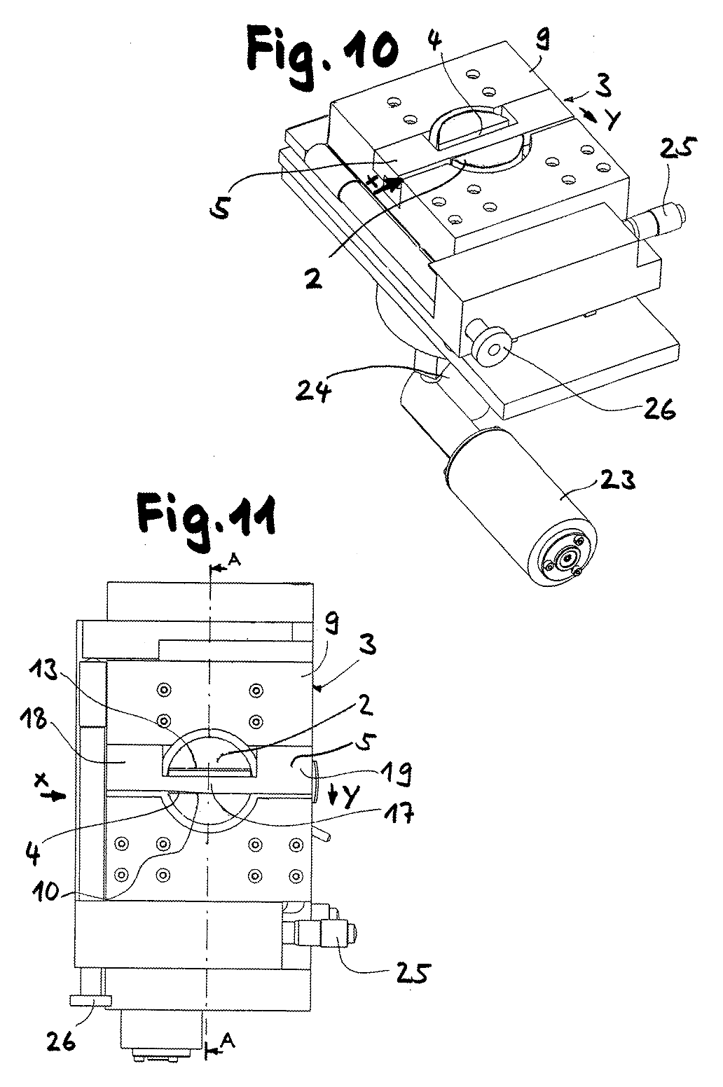

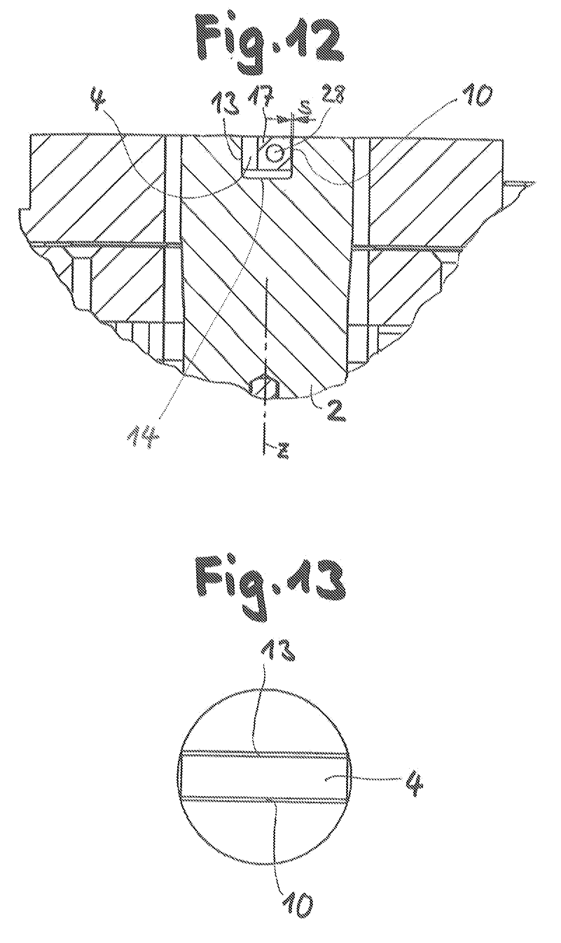

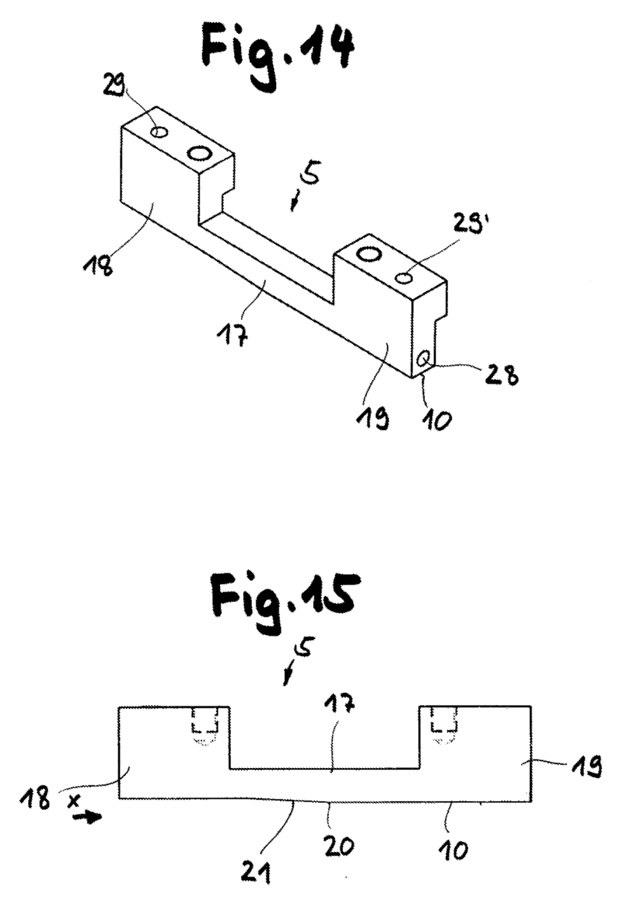

FIG. 4 shows a further sectional representation of the device (sectional plane y-z),

FIG. 5 shows a plan view of a sonotrode and an engaging element, inserted in a slit of the latter, of the device according to a second exemplary embodiment,

FIG. 6 shows a cross-sectional representation of the arrangement according to FIG. 5,

FIG. 7 shows a perspective, greatly simplified representation of a device according to the invention according to an alternative exemplary embodiment,

FIG. 8 shows a side view of the device according to FIG. 7,

FIG. 9 shows a perspective representation of a sonotrode for a further exemplary embodiment of a device for ultrasonic welding,

FIG. 10 shows a perspective representation of the device according to a further exemplary embodiment,

FIG. 11 shows a plan view of the device according to FIG. 10,

FIG. 12 shows a detail of a cross section through the device according to FIG. 10 in an enlarged representation,

FIG. 13 shows a plan view of a sonotrode of the device according to FIG. 10,

FIG. 14 shows a perspective representation of an engaging element of the device according to FIG. 10, and

FIG. 15 shows a plan view of the engaging element.

FIG. 1 shows a simplified representation of a device for ultrasonic welding designated as a whole by 1. The device has, as the main components, a sonotrode 2, which can be induced to undergo torsional ultrasonic vibrations by means of exciters (not represented here), and an anvil 3. The sonotrode 2, the longitudinal axis of which extends in the z direction, is of a cylindrical configuration, at least in the region of the free end. The torsional vibrations of the sonotrode are indicated by the arrow R. The anvil has an engaging element 5, which is inserted in a slit 4 in the region of a free end of the sonotrode 2. A lateral delimiting area of the slit forms a working area of the sonotrode. This and the following exemplary embodiments concern a variant in which the slit is assigned to the sonotrode and the engaging element is assigned to the anvil. Theoretically, however, a converse configuration is also conceivable. In this case, therefore, the slit would be assigned to the anvil and the engaging element would be assigned to the sonotrode. Since the construction and the mode of operation described here can be transferred to the second variant in an approximately analogous way, the second variant is not shown or described any further.

With the device 1, two films of plastic 11 and 12 lying one on the other can be welded to each other at the borders. For this purpose, the films 11, 12 are guided through a welding gap, which is formed by a lateral delimitation of the slit 4 and the engaging element 5 inserted therein, and welded under the effect of torsional vibrations. In this way, a longitudinal seam is produced at the borders. The device is suitable for welding two films, and in particular films of plastic, at the borders. It goes without saying that, if required, three or more films could be joined to one another. Furthermore, the continuous notching of films (scoring, for example as an aid for tearing open) or the complete continuous separation or cutting and sealing of films is also possible with the device. Instead of plastics, the processing of other materials is also conceivable, foils of metal coming into consideration in particular. Sheet-like formations of paper coated with plastic or other laminates are then also suitable for welding with the device that is described in more detail below.

In FIG. 2, the sonotrode 2 is in a waiting position. To produce the working position (see FIG. 1), the sonotrode must be displaced in the z direction by drive means (not represented here) of a lifting and lowering device, or else, if need be, manually. In the first exemplary embodiment, the engaging element 5 is formed in one piece on the anvil 3, and is consequently of a substantially rigid configuration. Furthermore, it can be seen from FIG. 2 that the upper side 6 of the engaging element 5, referred to hereafter as the engaging portion, is of a planar configuration and lies on the x-y plane. The engaging element 5 has a supporting segment 31 on the end face. This engaging element 5 serves for axially supporting the sonotrode 2 in the working position (FIG. 1). By way of example, the supporting segment 31 is configured as a cone-shaped projection.

Sectional representations of the device are shown in FIGS. 3 and 4. It can be seen from FIG. 3 that the length of the engaging element 5 is greater than the diameter of the sonotrode 2 and that the engaging element 5 protrudes beyond the slit 4 on both sides. FIG. 3 also shows that the slit 4 is a continuous longitudinal groove extending in the x direction. When the articles 11, 12 are guided past, through the arrangement with the welding gap, the articles to be processed are exposed approximately perpendicularly (i.e. in the y direction) to impulses in the ultrasonic range. In other words, although the device according to the invention uses torsion sonotrodes, the articles to be joined are actually subjected to longitudinal impulses. In this case, the width of the weld seam is defined for instance by the depth of penetration of the engaging element 5 into the slit 4.

As revealed by FIG. 4, the groove is recessed with respect to the end face 15 of the sonotrode 2 in the direction of the longitudinal axis, or therefore in the z direction. FIG. 4 reveals that the gap 4 is configured as a cross-sectionally rectangular groove, the groove depth being designated by t and the groove width being designated by b. The groove depth t lies, for example, between 5 and 30 mm and preferably between 10 and 15 mm; the groove width b lies between 5 and 15 mm and is preferably approximately 10 mm. The gap size of the welding gap is designated by s. The slit has two side walls 10, 13 extending plane-parallel to each other, the side wall 10 facing the films 11, 12 and forming a planar working area 10. The distance of the working area 10 from the engaging portion 6 establishes the gap size s of the welding gap. The supporting segment 31 forms in the axial direction an approximately punctiform stop of the engaging element 5 with respect to the sonotrode 2. As FIG. 4 shows, the supporting segment, formed as a cone-shaped projection, extends in the axial direction; as can be seen, the cone tip lies on the z axis.

As a difference from the previous exemplary embodiment, in FIG. 5 the engaging element 5 is not rigidly connected to the anvil, but resiliently mounted on it. Corresponding springs are indicated by 7 and 8. With these springs 7, 8 it is possible to achieve the effect that, as it passes through the welding gap, the film to be welded undergoes pressing, or a compressive force, under the action of a prestressing force. Furthermore, the floating mounting of the springs 7, 8 can also bring about the effect that the engaging element can perform pivoting movements. The corresponding pivot axis is in this case identical to the longitudinal axis z. The engaging element 5 has in the region of the engaging portion 6 a rocking edge 20, which is adjoined by a tapering area 21.

To set the width of the welding gap and/or set the pressing pressure, the engaging element 5 is secured to an anvil holder movably in the y direction by means of an adjusting mechanism (not represented here).

In FIG. 5, ribs designated by 16, the exact configuration of which is shown by FIG. 6, can then be seen. FIG. 6 shows a side view with the sonotrode and the engaging element 5. As can be seen, the formed working area 10 is contoured and has a plurality of rib-like projections 16 extending in the x direction. By contrast with contourless configurations, the rib arrangement (or some other surface profiling or contour) leads to a welded joint in which not the entire overlapping region is welded. The rib contour performs the function of an energy director. This makes it possible for energy to be introduced into the welding zone in a specifically directed manner. In FIG. 6, a supporting segment 31 can also be seen. As a difference from the previous exemplary embodiment (cf. FIG. 4), however, the supporting segment 31 is not assigned to the engaging element, but to the slit. The supporting segment 31 is a cone-shaped projection arranged approximately centrally in the groove base 14. As can be seen, the cone tip lies on the z axis and consequently forms an advantageous fixed stop or zero-point contact, which is not involved in the vibration occurring in the ultrasonic welding process.

In FIGS. 7 and 8, an alternative device 1 for ultrasonic welding is represented in a simplified form. By contrast with the exemplary embodiments described above, the sonotrode has no slit. Instead, the sonotrode 2 has a step-like cutout, which forms a working area designated by 10 (FIG. 8). The upper side of the anvil 3 that is facing the working area of the sonotrode 3 forms the engaging portion 6. The engaging portion 6 forms for the transport of the films 11, 12 during the ultrasonic welding, a sliding area for the films. As FIGS. 7 and 8 show, in the neutral position, the engaging portion 6 and the working area extend parallel to the longitudinal axis z of the sonotrode 2. The two films, lying one on the other, are guided between the engaging portion 10 and the working area 10 to achieve the welded joint; the films are subjected to ultrasonic vibrations by the sonotrode 2.

A further alternative configuration of a sonotrode is shown in FIG. 9. The sonotrode has a flattened profile, which extends in the longitudinal direction z and is formed on a cylindrical main body. The profile has a profile side which extends approximately parallel to the longitudinal axis z of the sonotrode 2. This profile side is designated in FIG. 9 by 10 and forms a working area for subjecting articles to ultrasonic vibrations.

FIG. 10 shows a structural configuration of a device for ultrasonic welding of the type described in FIGS. 1 to 4. The device 1 has a converter 23, which is connected to a torsional vibrator 24. The torsional vibrator 24 is for its part connected to the sonotrode 2. The anvil 3 has an anvil holder 9, to which the engaging element 5 is secured. In order that the vibrations cannot be transferred to the anvil holder 9, the latter is of a comparatively solid form. The device has an adjusting mechanism with which the position of the engaging element 5 in the slit 4 of the sonotrode 2 can be changed. A setting screw for displacing the engaging element in the y direction is designated by 25 and a setting screw for setting the angular position of the engaging element in the gap is designated by 26. The direction of advancement of the articles to be welded to each other is indicated by the arrow x. With this device, welding of very thin-walled articles, such as films or membranes, is also possible in particular. For the operation of the device 1, ultrasound in the frequency range from about 20 kHz to kHz has proven to be advantageous in tests. The vibration amplitude in this case lies approximately in the range from 25 to 30 μm.

It can be seen from the plan view according to FIG. 11 that the engaging element 5 is at a slight (and barely perceptible) distance away from the working area 10 of the sonotrode 2, and so forms an advantageous welding gap (cf. in this respect the following FIG. 12). To produce a pressing pressure, the engaging element 5 is supported in the y direction against the sonotrode 2 under a prestress by spring means (not represented here). In the direction opposite the direction of advancement x, i.e. in the region on the inlet side, the intermediate space between the anvil and the sonotrode is widened, and so forms an insertion gap for facilitated insertion of the films into the welding gap.

In FIG. 12, the welding gap is designated by s. Between the side wall 10 that forms the working area and a web portion 17 of the engaging element 5 that is received in the slit is the welding gap, which, for commonly used thin films, may be approximately 0.01 mm. Furthermore, FIG. 12 shows grooves designated by 30 and 30′ as well as a cooling channel 28, through which a coolant can be conducted. In the working position shown in FIG. 12, the web portion 17 is free with respect to the longitudinal direction, or does not come into contact with the base 14 of the groove. It goes without saying, however, that axial supporting of the engaging element on the anvil could also be provided here. For example, a supporting segment could be provided, either assigned to the engaging element or assigned to the base of the slit by analogy with FIG. 4 or FIG. 6.

In FIG. 13, the sonotrode is represented in a plan view. It can be clearly seen from FIG. 13 that the slit 4 is configured as a longitudinal groove with a groove width b. The slit 4 has two side walls 10 and 13, lying opposite each other and extending approximately parallel, the side wall 10 forming the working area for subjecting the articles to ultrasonic vibrations. To adjust the amplitude or balance the masses, cutouts or recesses that can stabilize the function of the sonotrode may be provided, created in the end face of the sonotrode for example by milling operations.

In FIGS. 14 and 15, the engaging element 5 is represented. This component is of an approximately U-shaped configuration and has two securing arms 18 and 19 and a web portion 17 connecting them. In FIG. 14, inlets and outlets 28, 29 and 29′, created by bores, for cooling channels can be seen, by way of which a coolant can be conducted into and out of the engaging element. Then, threaded bores (not designated any more specifically) for securing the engaging element to the anvil holder are arranged on the inside next to the bores designated by 29 and 29′. The engaging element 5 may be a one-piece component of steel created by drilling and milling operations.

FIG. 15 then shows that the engaging element 5 has on the inlet side a straight portion and, adjoining it in the x direction, an oblique portion (tapering portion) 21. The tapering portion 21 ends in the edge 20, which is then adjoined by the actual engaging portion 10 for the welding. The preferably central edge 20 preferably serves as a fixed stop point, which is not involved in the vibration occurring in the ultrasonic welding process. The first-mentioned portion and the tapering portion 21 define the insertion gap by way of which the articles to be welded can be inserted in a simple manner into the welding gap assigned to the engaging portion 10. In the insertion gap, i.e. up to the edge 20, no welding takes place.

From the edge 20, the welding amplitude increases continuously.

1. A device for the ultrasonic treatment, in particular for the ultrasonic welding, of at least two preferably sheet-like articles (11, 12), in particular films of plastic, or for the ultrasonic notching or separating and sealing of at least one preferably sheet-like article, comprising a sonotrode (2) and an anvil (3) lying opposite the sonotrode, it being possible for the sonotrode to be induced to undergo torsional ultrasonic vibrations by means of exciters (23, 24), wherein, to achieve a welded joint, a notching or a separation, the at least one article (11, 12) can be guided through between the sonotrode (2) and the anvil (3), the anvil (3) having an engaging portion (6), along which the at least one article (11, 12) can be guided, and the sonotrode (2) having a working area (10) for subjecting the at least one article to ultrasonic vibrations, the engaging portion (6) and/or the working area (10) extending at least section wise approximately parallel to the longitudinal axis (z) of the sonotrode, at least in a neutral position.

2. A device according to claim 1, wherein, to define the working area (10), the sonotrode (2) has a tongue (4) arranged on the end face and extending in the direction of the longitudinal axis (z).

3. A device according to claim 1, wherein, to define the working area (10), the sonotrode (2) has at least one slit (4), into which at least one engaging element (5) of the anvil (3) that forms the engaging portion (6) can be inserted, or is inserted, so that a gap, in particular a welding gap, for the at least one article (11, 12) is formed between the engaging portion (6) and the working area (10).

4. A device according to claim 3, wherein the slit (4) is a groove extending in a groove direction (x), the groove direction (x) extending transversely, preferably at right angles, to the longitudinal axis (z) of the sonotrode.

5. A device according to claim 3, wherein the slit (4) is a groove which is recessed with respect to an end face (15) in the direction of the longitudinal axis (z).

6. A device according to claim 3, wherein the slit (4) has two side walls (10, 13) lying opposite each other, one of the side walls (10) forming the working area for subjecting the at least one article to ultrasonic vibrations.

7. A device according to claim 1, wherein the engaging element (5) or the sonotrode (2) is supportable or supported by spring means (7, 8) for producing a prestressed pressure for pressing against the working area.

8. A device according to claim 2, wherein the engaging element (5) or a part of the anvil is mounted on an anvil holder (9) pivotably about a pivot axis, the pivot axis extending parallel to the longitudinal axis (z) of the sonotrode.

9. A device according to claim 3, wherein the engaging element (5) is of an approximately U-shaped or bow-shaped configuration and, to form the U or bow shape, has two securing arms (18, 19) and a web portion (17) connecting them, the web portion (17) being received, or able to be received, in the slit (4).

10. A device according to claim 3, wherein the engaging element (5) is longer than the slit (4) with respect to the groove direction (x) and preferably protrudes beyond the slit (4) on both sides.

11. A device according to claim 3, wherein the engaging element (5) has in the region of the engaging portion (6) a preferably central edge (20) and at least one tapering area (21) adjoining the edge.

12. A device according to claim 1, wherein the working area (10) is contoured.

13. A device according to claim 3, wherein the engaging element (5) or the slit (4) has a supporting segment (31) for the axial support of the sonotrode (2).

14. A method for the ultrasonic treatment, in particular for the ultrasonic welding, notching or cutting and sealing, of at least one preferably sheet-like article or of at least two preferably sheet-like articles (11, 12), in which the at least one preferably sheet-like article (11, 12) is guided between a sonotrode (2) and an anvil (3), wherein the sonotrode (2) is set in torsional vibrations by means of exciters (23, 24) and in that, to achieve a welded joint, notching or separation, the at least one article (11, 12) is guided between an engaging portion (6) that is assigned to the anvil (3) and extends approximately parallel to the longitudinal axis (z) of the sonotrode and a working area (10) of the sonotrode (2) that extends approximately parallel to the longitudinal axis (z) of the sonotrode, at least in a neutral position.

15. A method according to claim 13, wherein the articles are guided at the borders through a gap, the gap being formed by a slit (4) that is assigned to the sonotrode (2) and by an engaging element (5) that is assigned to the anvil (3) and is inserted into the slit.
